(19) United States
(12) Patent Application Publication
(10) Pub. No.: US 2002/0168497 A1
(43) Pub. Date: Nov. 14, 2002

(54) Non woven loop forming material

(76) Inventors: Donald H. Lester, Waxhaw, NC (US); Steven Floyd Nielsen, Charlotte, NC (US); Bryan P. Thomas, York, SC (US)

Correspondence Address: T. Peige Wise, Adams, Schwartz & Evans, P.A., 2180 Two First Union Center, Charlotte, NC, 28282, US

(21) Appl. No.: 09/853,213

(22) Filed: May 11, 2001

(51) Int. Cl. B32B 3/06

(52) U.S. Cl. 428/100; 428/99

(57) ABSTRACT

Loop forming material, wherein said material comprises crimped tows of continuous filaments, said material having a thickness comprised between 0,1 mm and 3 mm and a weight comprised between 15 g/m² and 100 g/m².

The present invention relates to a loop forming material, in particular for use as a female part of a hook and loop mechanical fastener, as well as to a method to produce such loop forming material.

The present invention also relates to a laminated assembly comprising such a loop forming material and to a female part of a mechanical fastener comprising such a loop forming material or such a laminated assembly comprising such a loop forming material.

In today mechanical fasteners, in particular for diapers, the female part generally comprises, for the formation of loops, a knitted fabric with loops. These knitted fabrics with loops are fabricated by weaving processes. The drawback of these weaving processes, in particular with a three bars system, for respectively the weft yarns, the warp yarns and the loop yarns, is their slow rate or speed of production. Indeed, it is difficult with such processes to have a speed or rate of production higher than 10 to 15 meters/minute. It results from this that to deliver large volumes of loop forming materials in the form of fabrics, the manufacturer has to invest in a high number of weaving machines.

The present invention provides a loop forming material, for use in particular in a female part of mechanical fastener or a self gripping device, in particular in the field of diapers and hygienical disposable products, that can be produced in large volumes at high speeds or rates.

According to the present invention, the loops forming material comprises at least one crimped tow of continuous filaments, said loops forming material having a thickness comprised between 0.1 mm and 3 mm and a weight comprised between 15 g/m² and 100 g/m².

A crimped tow of continuous filaments is a large assembly' of continuous filaments made with no net torsion, assembled in the shape similar to a loose rope and maintained together by crimping.

By using crimped tows of continuous filaments to produce the loop forming material, one can then produces this loop forming material from non-woven materials at high speeds and the limitations of the low speed production in the case of knitted fabrics are overcome.

In a preferred embodiment, the tows are bonded together in discrete bonding points or along bonding lines, preferably at regularly spaced intervals.

By bonding the tows to form a loop forming material, one makes sure on one hand that the crimping will stay sufficiently large so that the loop forming material will have loops with a sufficient height to be used as a female part of a self-gripper and, on the other hand, that the loop forming material will maintain a good uniformity, which will result in a sensibly constant performance in peel and shear force tests on the whole surface of the loop forming material. Finally, by bonding them together, one makes sure that the loop forming material will stay well “open” and will not flatten itself, flattening that would otherwise be a drawback for the use of the material as a female part of a self-gripper.

In a preferred embodiment of the present invention, the continuous filaments are made from polyolefins, polyamides, cellulose acetates or others thermoplastic materials, in particular Fiberfill (registered trademark).

In a preferred embodiment of the present invention, the continuous filaments have an individual fiber denier comprised between 1.5 and 15 dpf.

In a preferred embodiment of the present invention, the loop forming material has a crimp level comprised between 6 and 12 crimps per inch.

In a preferred embodiment of the present invention, the crimped tows are bonded together at bonding points which have a configuration forming an hexagonal network.

In a preferred embodiment of the present invention, the bonding points of the bonding configuration are made by thermal bonding, by ultrasonic bonding or by using an adhesive binder.

The present invention also provides a laminated assembly comprising a substrate on which said loop forming material is bonded, in particular through lamination using an adhesive or a thermal bonding or a ultrasonic bonding process.

The present invention also provides a female part of a self gripper comprising a loop forming material as defined above or a laminated assembly as defined above.

The present invention also provides a baby diaper or a hygienical disposable product comprising a female part of a self-gripper as defined above or a loop forming material as defined above or a laminated assembly as defined above.

The present invention also provides a fabrication method of a loop forming material as defined above. The method according to the invention comprises the steps of:

opening and spreading crimped tows of continuous filaments to obtain a given thickness and a given weight for said loop forming material.

In a preferred embodiment, said method also comprises the step of:

making a bond, in particular a thermal bond, in discrete points of said tows to define discrete loops.

In a preferred embodiment said loops forming material is fixed to an appropriate substrate.

A preferred embodiment of the present invention is now described, in reference to the drawings, in which

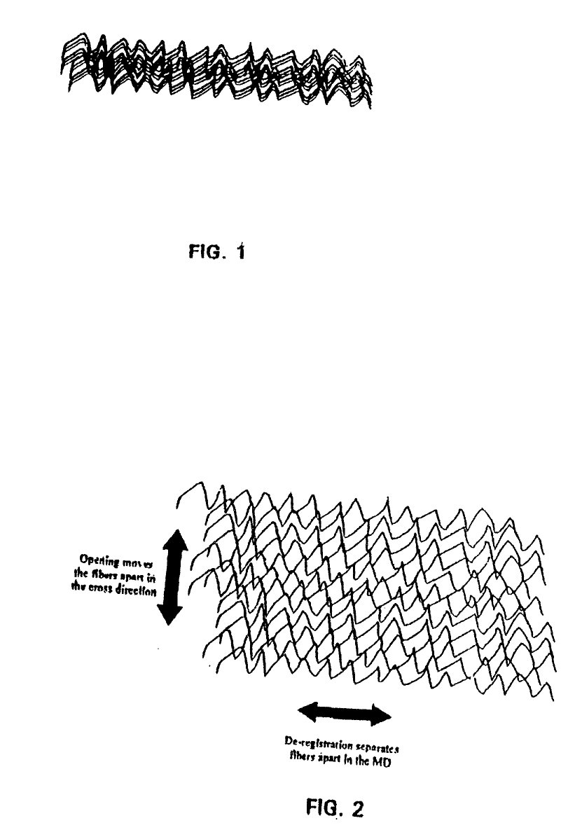

FIG. 1 is a perspective view of crimped tows of continuous filaments at the initial stage

FIG. 2 is a view of the loops forming material of FIG. 1 after the opening and separation (or de-registering) steps have been completed, respectively in the machine direction and the transversal direction to the machine direction,

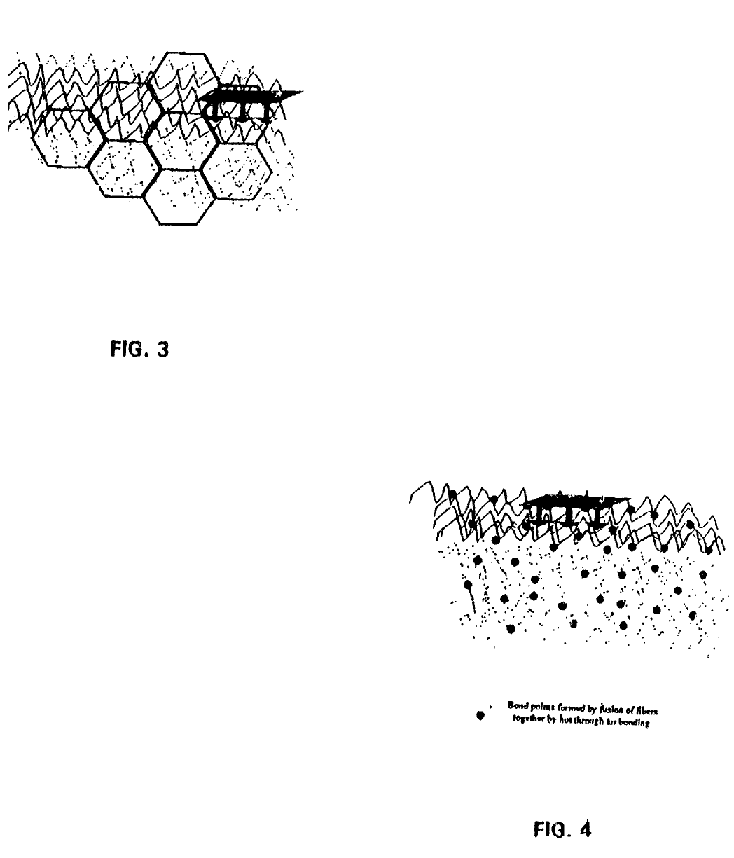

FIG. 3 is a perspective view of the loop forming material of FIGS. 1 and 2, comprising a network of bonding points,

FIG. 4 is a view identical to the view of FIG. 3, comprising a network of bonding lines, in an hexagonal or bees nest shape, and

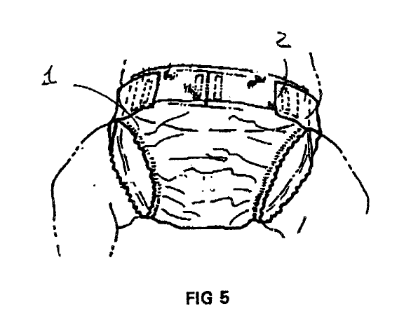

FIG. 5 is a perspective view of a diaper comprising a self gripper having a female part comprising a loop forming material of the present invention.

The starting material is a crimped tow of continuous filaments. These materials are commercially available from companies including DuPont, Kosa and others in the USA. Available materials, typically polyester, are called “fiberfill”. Fiberfill (registered trademark) is currently used for insulation and cushioning applications including pillows, mattresses and furniture. These materials are inexpensive and resilient. This is why they are used in these types of applications. Special tows produced from other fibers, deniers, fiber count and crimp level can be produced. These include polyolefins, polyamides, cellulose acetates, bicomponent fibers and other thermoplastic materials.

The tow is first opened and de-registered using a “threaded roll” process. Several sequential steps of threaded roll processing are required to achieve the desired level of filament opening and deregistration, web width and thickness. Threaded roll processes are described in various patents including U.S. Pat. Nos. 3.032.829, 3.156.016, 3.505.155 and others.

Once said material opened and de-registered, that is open in the machine direction and separated or de-registered in the transversal direction, bonding points are made at regular intervals on the surface of the crimped tows.

This can be accomplished via one or more methods. These include: 1) passing the web through a set of calendar rolls which bond points or areas of the web at regular intervals, 2) the same as 1) except using ultrasonic welding, or 3) bonding the fibers using hot through air thermal bonding, or 4) using an adhesive binder. When hot through air bonding is used, the use of bicomponent fibers which have low melting point sheath may be preferred.

Finally, the web is dimensionally stabilized by attaching it to a suitable substrate such as a film or a non woven fabric. This could be the back sheet of a diaper. This bonding can be accomplished by any of a number of ways including lamination used adhesive or thermal bonding.

Additionally, the webs can be cross-lapped to obtain fibers that are oriented in the cross direction as well as the machine direction, which gives the web more loft and the potential for deeper hook engagement.

The resulting loop material weighs in the range of 15-100 g/m², has good fastening properties, is soft, uniform and resilient.

With this processing technique, loop material can be produced at widths up to 3 meters or greater at a speed of at least 30 meters per minute.

The production of loops suitable for mechanical fastening can be engineered with the proper choice of tows including fiber type, denier, fiber count and crimp level and the degree of fiber opening including fiber spacing and web thickness.

The individual fiber denier and crimp level can be selected to achieve the desired level of fastening performance for a particular hook. For example, for a hook with a relatively large profile, fiber would be preferred with a greater dpf and lower crimp level. The fiber with a greater denier and lower crimp level would tend to yield a web with loops that are more open which could be more readily engaged by a larger hook. For a hook with a smaller profile, the converse is true. A smaller dpf with a greater crimp level would yield a web with loops that are closer together and thus more suitable for engagement by a smaller hook. As expected, the selection of fiber denier can also directly impact the breaking strength of the fiber. This relates directly to fastening performance.

For the subject invention the total denier of the tow can range from 40.000 to 1000,000 depending on the target web thickness and width. The individual fiber denier can range typically from 1.5 to 15 dpf and the crimp level can range from 6 to 12 crimps per inch.

The loop fastening material disclosed in this invention overcomes the shortcomings associated with typical non woven processes used to process loop fastening material that were outlined above. A web with loops for mechanical fastening can be prepared from crimped tows of continuous filaments that are thin, lightweight and that have uniform spacing between fibers. Such a web structure contains filaments that extend in the z-direction and are suitable loops for engagement by fastening hooks. Finally, such a structure is resilient. The loops tend to stay open and available for fastening even after the material is put under compressive forces for a period of time.

FIG. 5 represents a baby diaper 1 which waist is provided with a self gripper having a male part and a female part 2. Said female part 2 comprises a loop forming material of the present invention which is laminated on a substrate, which substrate is fixated, on the side opposed to the loop forming material, to the diaper.

We claim:

1. Loop forming material, wherein said material comprises crimped tows of continuous filaments, said material having a thickness comprised between 0.1 mm and 5 3 mm and a weight comprised between 15 g/m² and 100 g/m².

2. Loop forming material as defined in claim 1, wherein said crimped tows are bonded together at bonding points or along bonding lines.

3. Loop forming material as defined in claim 2, wherein said bonding points or lines are spaced at regular intervals.

4. Loop forming material as defined in claim 2, wherein said bonding points or lines are disposed in a regular pattern.

5. Loop forming material as defined in claim 4, wherein said pattern is hexagonal or have a bees nest shape.

6. Loop forming material as defined in claim 2, wherein said bonding points or lines are made through a thermal bonding process or an ultrasonic process.

7. Loop forming material as defined in claim 1, wherein said tows comprise polyester.

8. Loop forming material as defined in claim 1, wherein said tows comprise polyolefine, polyamide, cellulose acetates or other thermoplastic material.

9. Loop forming material as defined in claim 8, wherein said tows are made of Fiberfill®.

10. Laminated assembly comprising a substrate on which is fixated a material comprising crimped tows of continuous filaments, said material having a thickness comprised between 0.1 mm and 3 mm and a weight comprised between 15 g/m² and 100 g/m².

11. Self gripper comprising a male part having hooking elements and a female part comprising a loop forming material, said material comprising crimped tows of continuous filaments and having a thickness comprised between 0.1 mm and 3 mm and a weight comprised between 15 g/m² and 100 g/m².

12. Self gripper comprising a male part having hooking elements and a female part comprising a laminated assembly comprising a substrate on which is fixed a material comprising crimped tows of continuous filaments, said material having a thickness comprised between 0.1 mm and 3 mm and a weight comprised between 15 g/m² and 100 g/m², the fixation being made through lamination by an adhesive, through thermal bonding or ultrasonic bonding.

13. Diaper comprising a self gripper comprising a male part having hooking elements and a female part comprising a material comprising crimped tows of continuous filaments and having a thickness comprised between 0,1 mm and 3 mm and a weight comprised between 15 g/m² and 100 g/m².

14. Diaper comprising a self gripper comprising a male part having hooking elements and a female part is comprising a laminated assembly comprising a substrate on which is fixated a material comprising crimped tows of continuous filament, said material having a thickness comprised between 0.1 mm and 3 mm and a weight comprised between 15 g/m² and 100 g/m², the fixation being made through lamination by an adhesive, through thermal bonding or ultrasonic bonding.

15. Manufacturing method of a loop forming material, wherein it comprises the steps, of opening and deregistering crimped tows of continuous filament to obtain a predetermined thickness and a predetermined weight for said loop forming material.

16. Manufacturing method as defined in claim 15, wherein it comprises the steps of making a thermal bonding at points of said tows to define a pattern of bonding points or lines to keep the loops opened and deregistered.
